(19) United States
(12) Patent Application Publication
(10) Pub. No.: US 2016/0328925 A1
(43) Pub. Date: Nov. 10, 2016

(54) POKER GAME WITH TWO ROUNDS OF COMPARISONS

(71) Applicant: SHENG-HUO CHENG, Taichung City (TW)

(72) Inventor: SHENG-HUO CHENG, Taichung City (TW)

(21) Appl. No.: 14/854,096

(22) Filed: Sep. 15, 2015

Related U.S. Application Data
(60) Provisional application No. 62/179,413, filed on May 6, 2015.

(51) Int. Cl. G07F 17/32

(52) U.S. Cl. CPC G07F 17/3293; G07F 17/3225

(57) ABSTRACT

In a poker game executable by a computer system or a robot, each participant gets five cards and distributes the five cards into a first group having two cards, and a second group having three cards. More particularly, a total score of the three cards of the second group is required to be ten points or a multiple of ten points. Next, the invention has two rounds of comparisons, wherein the first round of comparison is to compare total scores of the first groups, and the second round of comparison is to check five-card types of the participants. The interest and versatility of the poker game can be enhanced using the card distributing and two rounds of comparing steps of the invention.

The present application relates to and claims priority of U.S. Provisional Application Ser. No. 62/179,413, filed on May 6, 2015.

### BACKGROUND OF THE INVENTION

1. Field of the Invention

The invention relates to the technical field of a poker game, and more particularly to a poker or poker-like game with two rounds of comparisons.

2. Related Art

The typically known and frequently seen poker games comprise five-card draw, three-card poker, five-card stud, seven-card stud, Texas Hold'em, Black Jack and the like. Changes of these games usually relate to dealing and playing methods.

In China poker game, each player can get 13 cards from a deck of standard 52 cards. Each player must distribute these cards into three hands including a front hand of three cards, a middle hand of five cards and a back hand of five cards. Thereafter, the players compare the front hand of cards, compare the middle hand of cards and compare the back hand of cards according to the standard poker rule.

### SUMMARY OF THE INVENTION

An object of the invention is to provide a poker game with two rounds of comparisons to enhance the game interest and diversification.

To achieve the above-identified object, the invention comprises a computer system connected to a plurality of terminal devices each corresponding to a player. A game program is installed in the computer system and executes a dealing step, a distributing step, a first round comparing step and a second round comparing step. More particularly, each participant distributes obtained five poker cards into a first group and a second group in the distributing step, wherein the first group is composed of two poker cards, and the second group is composed of three poker cards. In the first round comparing step, scores of the first group are obtained by way of addition, and are then compared. In the second round comparing step, it is checked whether five cards of the player satisfy a requirement of a special card type, wherein once the five cards of the player satisfy the requirement of the special card type, the player only can obtain a reward of the special card type regardless of a result in the first round comparing step.

### BRIEF DESCRIPTION OF THE DRAWINGS

FIG. 1 shows the architecture of the invention executed in a computer system and terminal devices.

FIG. 2 is a block diagram showing steps of the invention.

FIG. 3 is a block diagram showing steps of the invention.

FIG. 4 is a schematic view showing a dealing step and a distributing step of the invention.

FIG. 5 is a schematic view showing a first round comparing state of a player A and a banker in the invention.

FIG. 6 is a schematic view showing the first round comparing state of a player B and the banker in the invention.

FIG. 7 is a further processing flow chart when the same total score is present in the first round comparing step of the invention.

FIG. 8 is a schematic view showing a second round comparing state of a player C in the invention.

FIG. 9 is a processing flow chart showing a result obtained after the second round comparing step and the first round comparing step are combined in the invention.

FIG. 10 is a schematic view showing that five cards of the player C in the second round comparing step of the invention satisfy the requirement of the special card type.

FIG. 11 is a schematic view showing execution in the computer system serving as the banker in the invention.

FIG. 12 is a schematic view showing that five cards of a player D in the second round comparing step the invention satisfy the requirement of the special card type.

### DETAILED DESCRIPTION OF THE INVENTION

The poker game of the invention may be played using a deck of physical poker cards. The deck of poker cards comprises 52 standard poker cards A [symbol] to K [symbol] , A♡ to K♡, A [symbol] to K [symbol] and A♦ to K♦. The deck of poker cards may be dealt by a suitable robot.

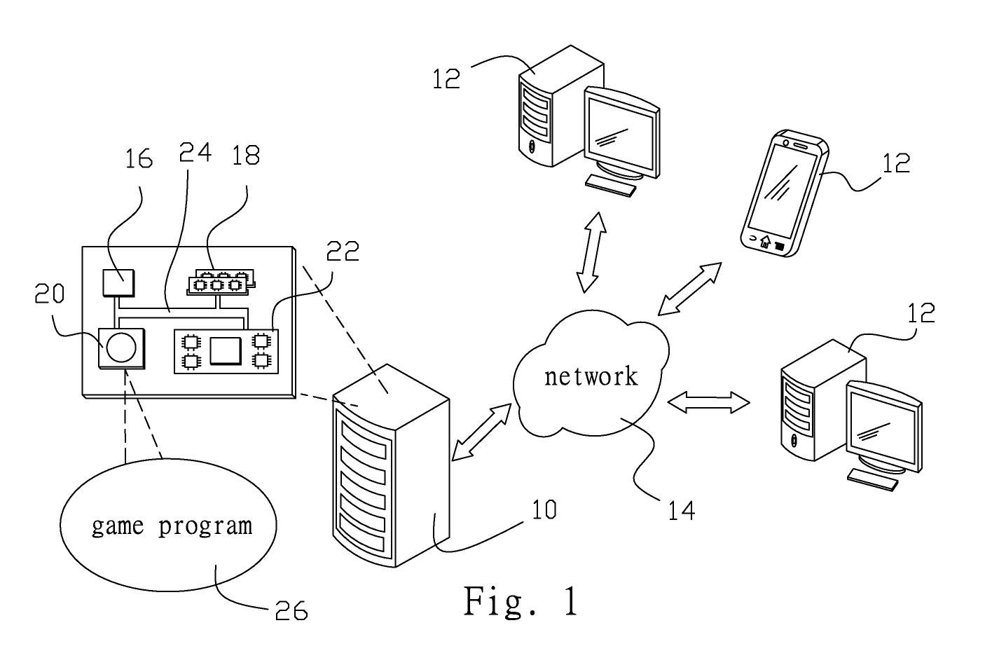

Referring to FIG. 1, the poker game of the invention may be executed in a computer system 10 and one or multiple terminal devices 12 connected to the computer system 10 through a network 14. The cards that may be displayed by the terminal device 12 pertain to one portion of the cards A [symbol] to K [symbol] , A♡ to K♡, A [symbol] to K [symbol] and A♦ to K♦.

The computer system 10 may comprise a processor 16, a memory 18, a storage device 20 and an input/output apparatus 22 which are electrically connected together via a suitable bus 24. It is worth noting that an executable game program 26 is installed in the storage device 20. The network 14 may be the wired/wireless Ethernet or Internet.

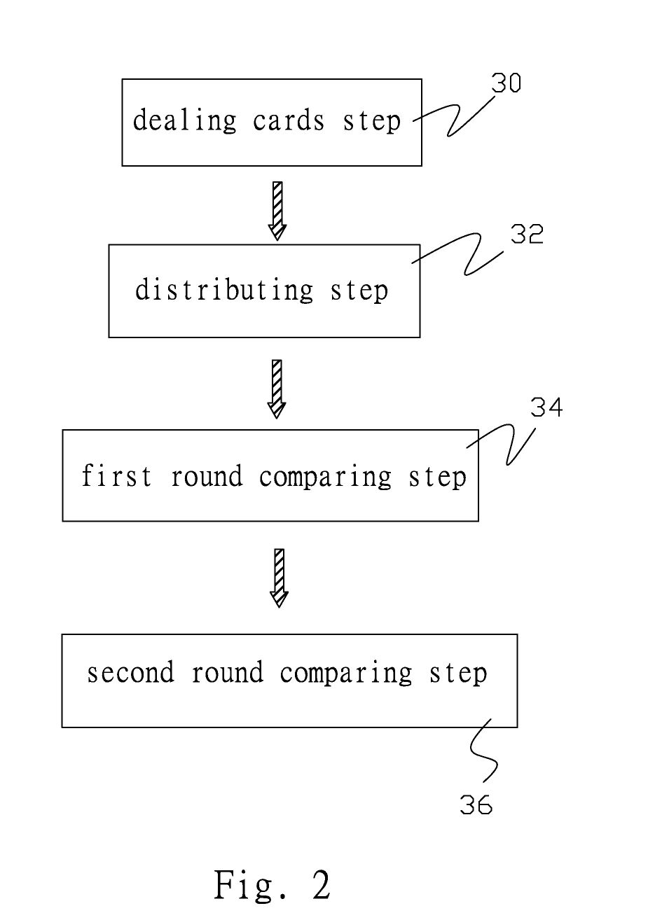

Referring to FIG. 2, the invention comprises a dealing step 30, a distributing step 32, a first round comparing step 34 and a second round comparing step 36.

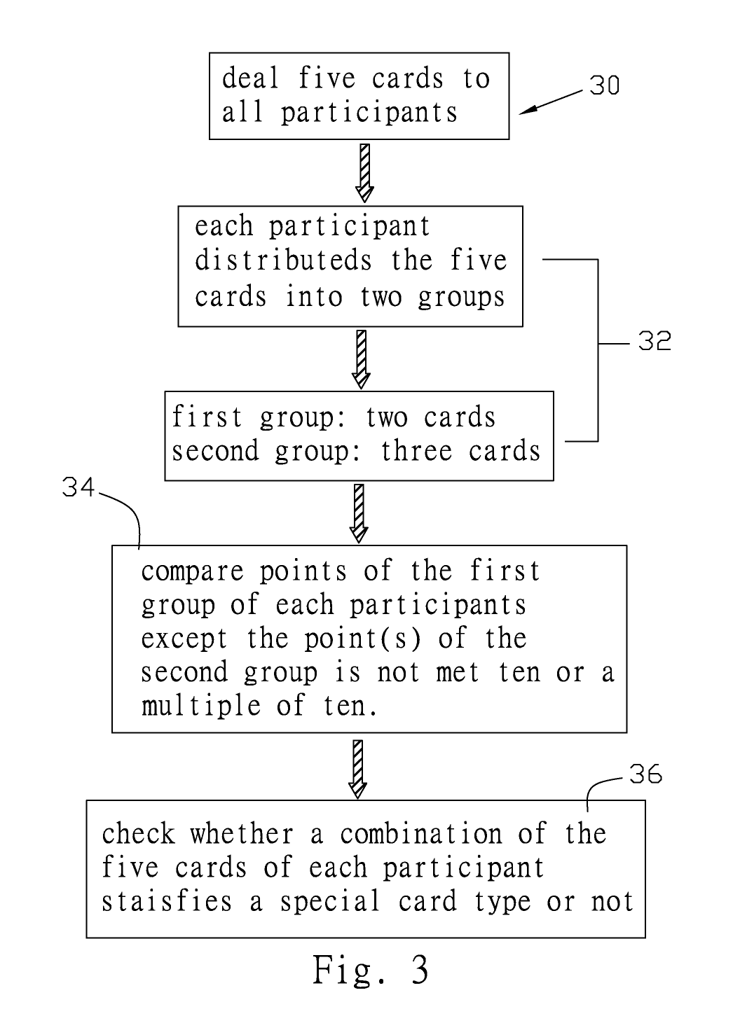

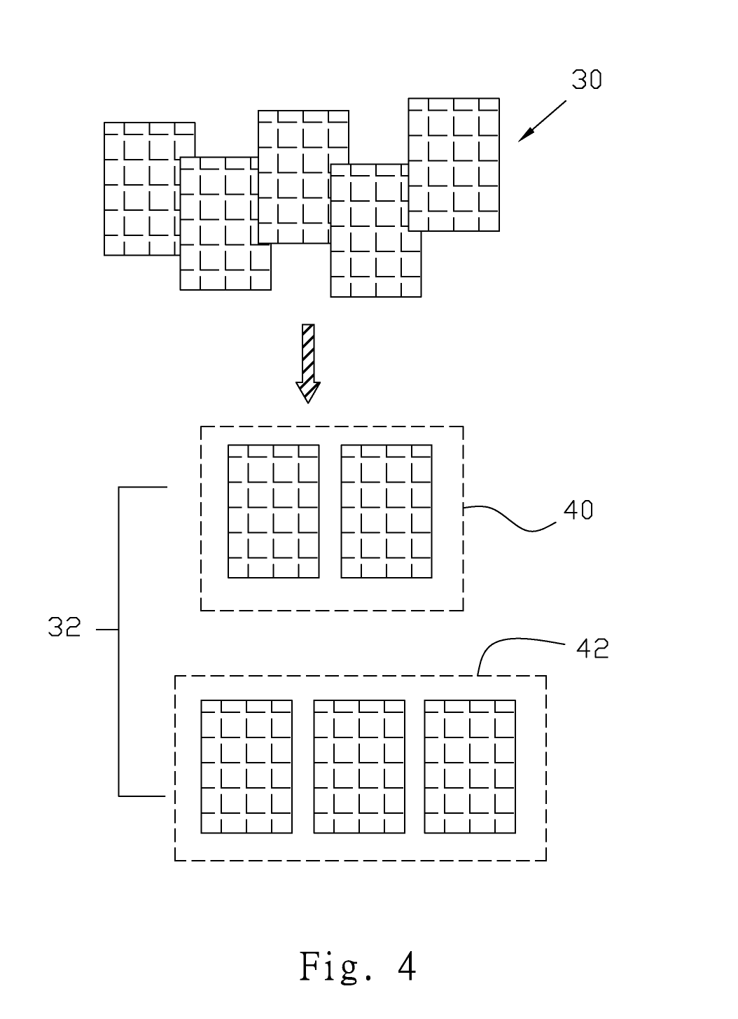

Referring to FIGS. 3 and 4, each participant (or player) may obtain five cards in the dealing step 30 when either a deck of physical poker cards is used to play the game, or the computer system and the terminal device(s) connected thereto are used to play the game. In addition, each participant does not know the contents of the cards obtained by other participants when each card is being dealt and obtained.

In the distributing step 32, each participant distributes the five poker cards into two groups, wherein the first group 40 is composed of two poker cards, and the second group 42 is composed of three poker cards.

In the poker game of the invention, the cards 10, J, Q and K are set to have the score of zero points, and the card A is set to have the score of one point. The scores represented by the cards are listed in the following Table 1.

TABLE 1

| CARD | SCORE |
|---|---|
| A | 1 |
| 2 | 2 |
| 3 | 3 |
| 4 | 4 |
| 5 | 5 |
| 6 | 6 |
| 7 | 7 |
| 8 | 8 |
| 9 | 9 |
| 10 | 0 |
| J | 0 |
| Q | 0 |
| K | 0 |

It is worth noting that the total score of the cards of the second group 42 must satisfy ten points or a multiple of ten points. In other words, each participant is requested to get rid of three cards, the total score of which is equal to the score of ten points or a multiple of ten points. If the total score of the second group of the participant in the distributing process cannot satisfy the zero point, ten points or a multiple of ten points, then the participant immediately becomes the loser. The participant ends the game once he or she becomes the loser in this process.

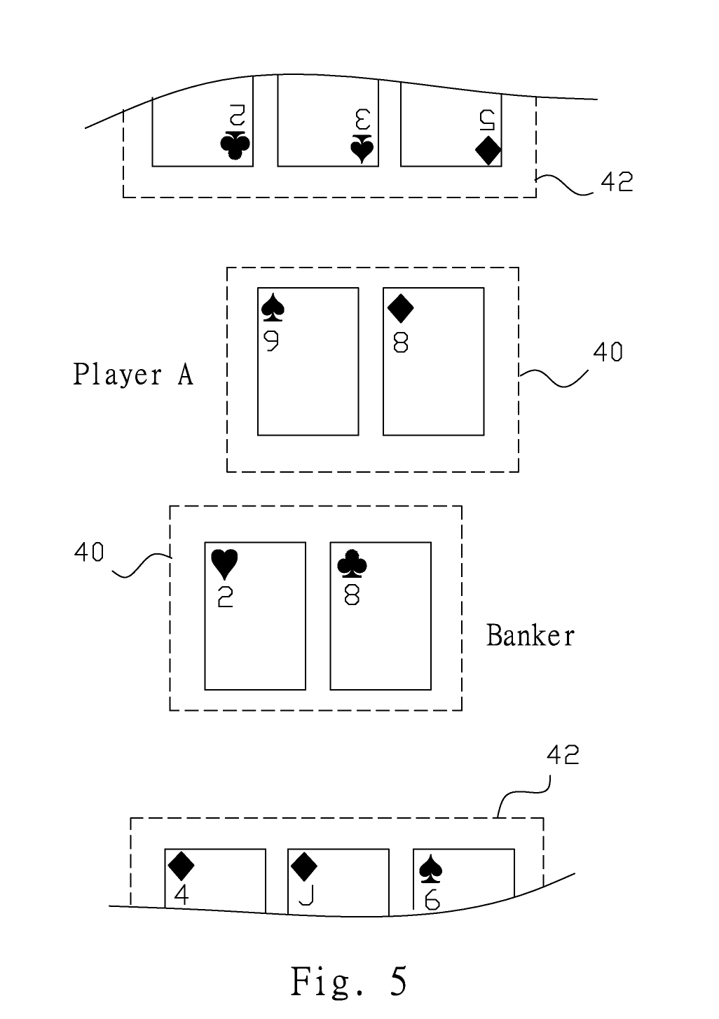

Referring to FIGS. 3 and 5, the invention has two rounds (times) of comparing steps. In the first round comparing step 34, each participant passing over the distributing step opens the first group 40 and the second group 42, and obtains the score of the cards of the first group 40 by way of addition. It is worth noting that if the total score of the cards in this game exceeds ten points, then the total score is reset as the total score minus ten points. In other words, the maximum of the total score of this game is equal to ten points, and the minimum thereof is equal to one point.

In a first example, as shown in FIG. 5, the five cards obtained by the banker are 2♡, 4♦, 6 [symbol] , 8 [symbol] and J♦, and distributed into the first group 40 of cards (2♡, 8 [symbol] ) and the second group 42 of cards (4♦, 6 [symbol] , J♦), so the banker obtains the total score of ten points; and the five cards obtained by the player A are 2 [symbol] , 5♦, 3 [symbol] , 9 [symbol] and 8♦, and distributed into the first group 40 of cards (9 [symbol] , 8♦), and the second group 42 of cards (2 [symbol] , 5♦, 3 [symbol] ), so the player A obtains the total score of seven points. Because the banker or the player who obtains the high score is determined as the winner, the banker is shown as the winner in the drawing.

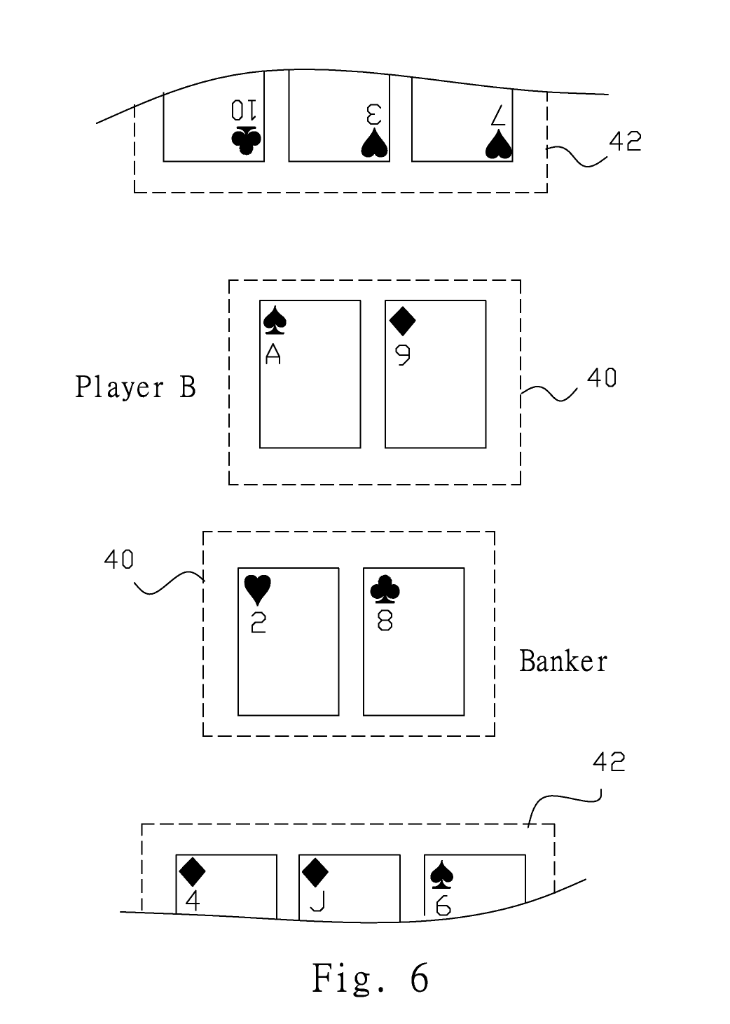

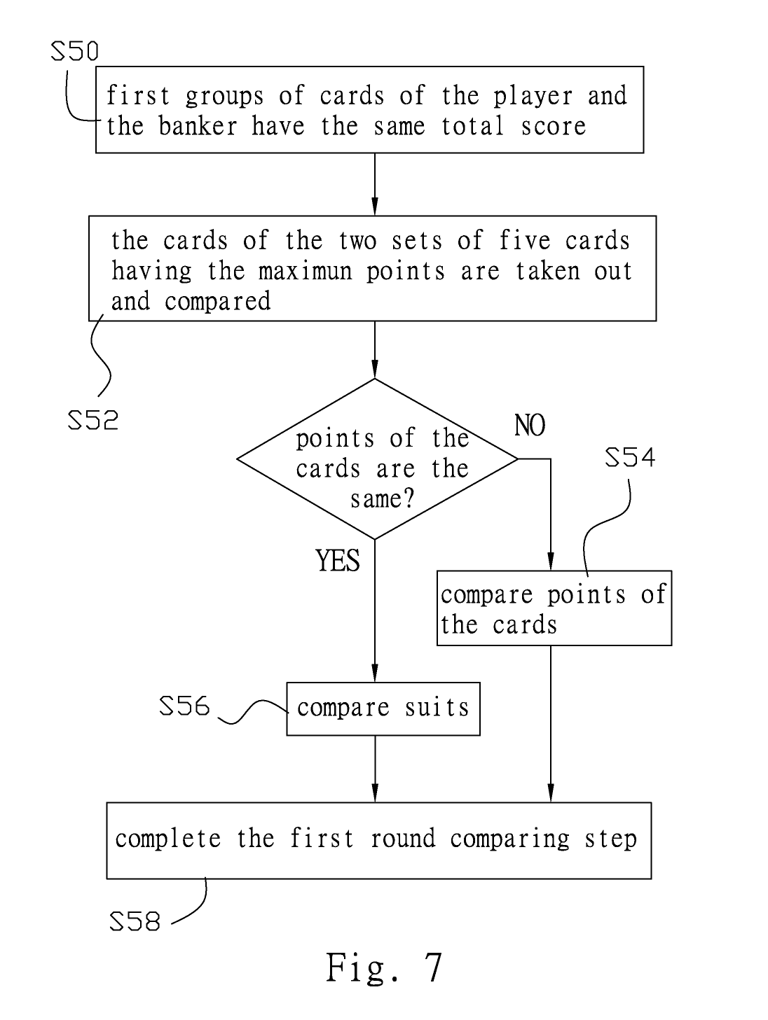

In a second example, as shown in FIGS. 6 and 7, the five cards obtained by the banker are 2♡, 4♦, 6 [symbol] , 8 [symbol] and J♦ and distributed into the first group 40 of cards (2♡, 8 [symbol] ), and the second group 42 of cards (4♦, 6 [symbol] , J♦), so the banker obtains the total score of ten points; and the five cards obtained by the player B are A [symbol] , 3♡, 7♡, 10 [symbol] and 9♦, and distributed into the first group 40 of cards (A [symbol] , 9♦), and the second group 42 of cards (3♡, 7♡ 10 [symbol] ), so the player B obtains the total score of ten points the same as those of the banker. According to the steps S50 and S52 shown in FIG. 7, the scores and suits of the maximum cards of the five cards of the banker and the players need to be further compared. Herein, the scores are firstly compared. If the scores are different, the scores are compared according to the requirement of step S54, and the first round comparing step is completed according to the step S58. If the scores of the player and the bankers are the same, then the suits of the cards are further compared according to the requirement of step S56, and the first round comparing step is completed according to the step S58. The scores are sequentially listed as K>Q>J>10>9>8>7>6>5>4>3>2>A, and the suits are sequentially listed as Spade [symbol] >Heart ♡>Diamond ♦>Club [symbol] . In the second example, the maximum score of the banker is J, and the maximum score of the player is 10, so the banker is determined as the winner.

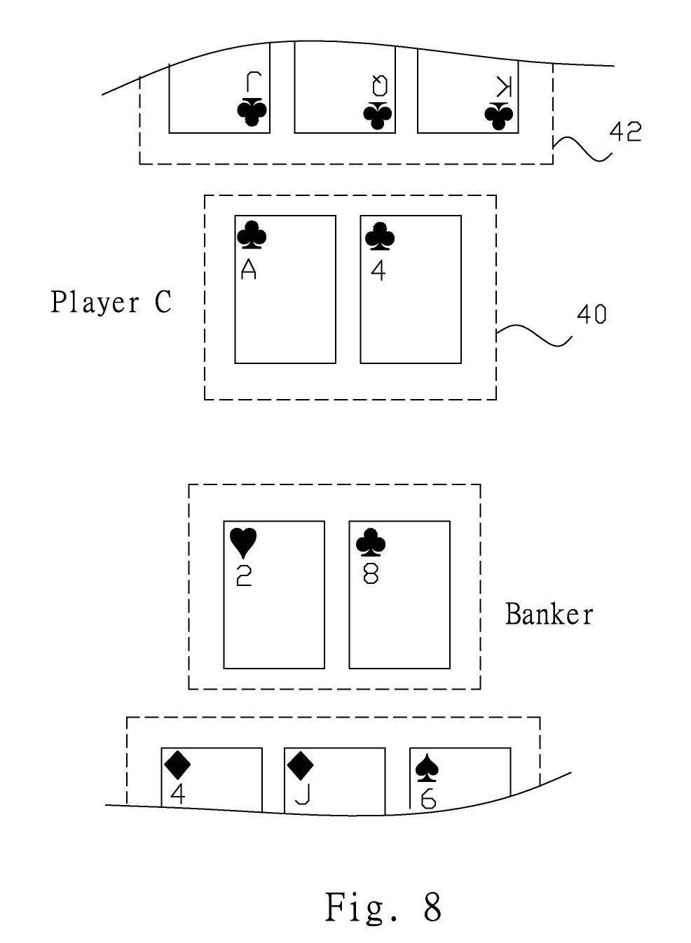

As shown in FIGS. 3 and 8, the participants finishing the first round comparing step 34 can participate in the second round comparing step 36. Each participant re-combines the first group 40 and the second group 42 of cards (i.e., the originally obtained five cards), and checks whether the re-combined cards satisfy the requirement of the special card type. It is worth noting that no comparison between the player C and the banker is executed in the second round comparing step 36.

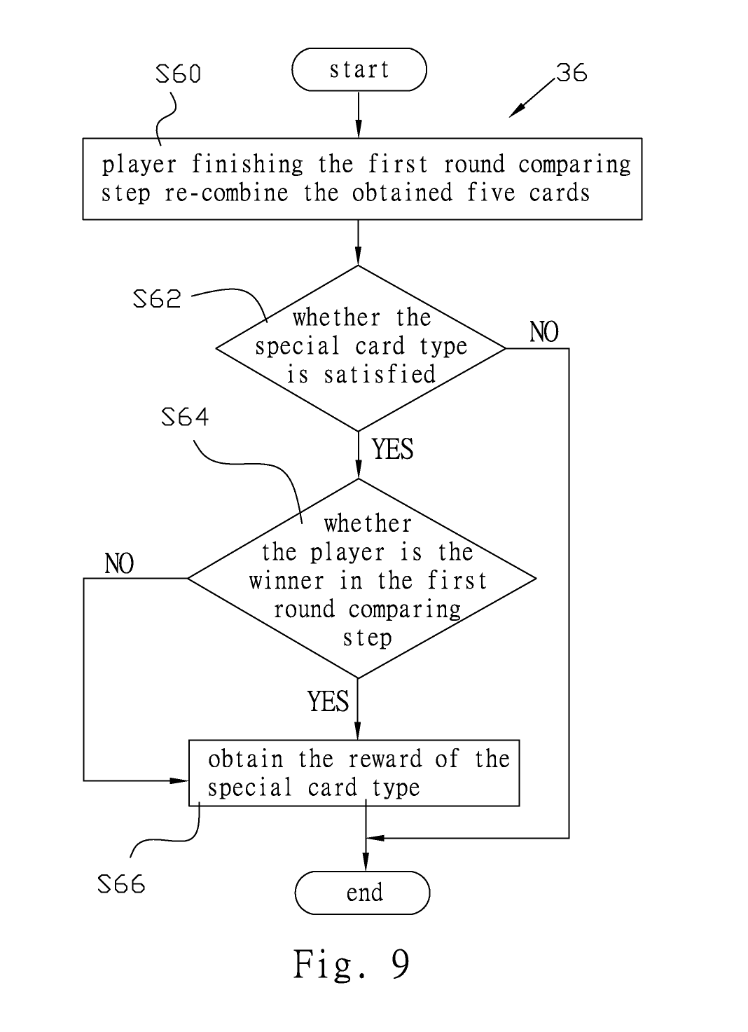

Referring to steps S60 and S62 of FIG. 9, according to the requirement of the second round comparing step 36, each player finishing the first round comparing step re-combines the obtained five cards, and further checks whether the re-combined cards satisfy the requirement of the special card type. According to steps S64 and S66, if the player is the loser in the first round comparing step, but the five cards of the player can constitute the special card type, then the player can get the reward of the special card type in the second round comparing step. However, when the five cards of the player (participant) constitute the special card type and the player is the winner in the first round comparing step, then the participant is also restricted to obtain the reward of the special card type only.

The special card type comprises one pair, two pairs, three of a kind, straight, flush, full house, four of a kind, straight flush and royal flush. In addition, different special card types can be increased or decreased and given with different rewards according to the actual situation of the game.

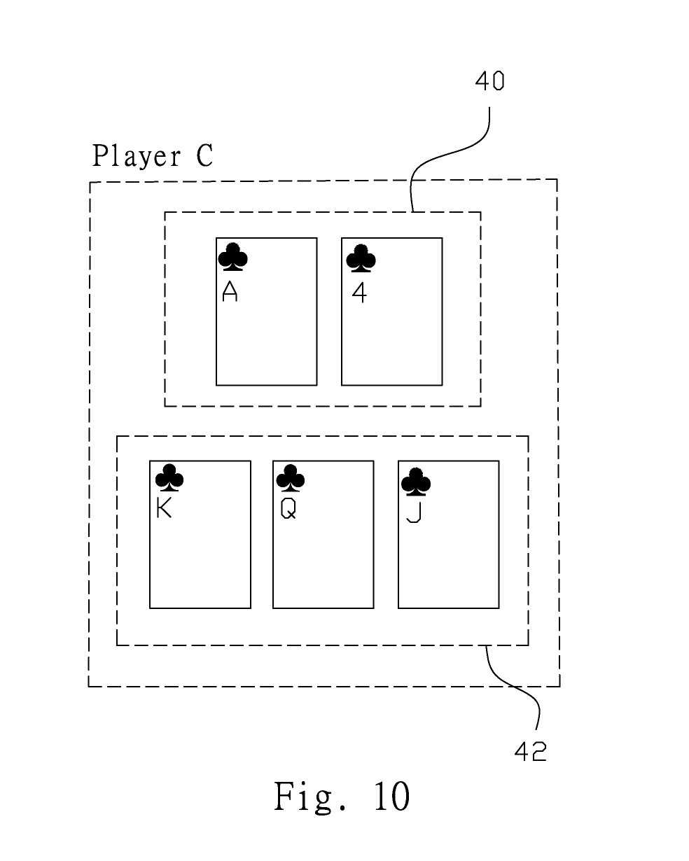

In a third example, as shown in FIG. 8, the five cards obtained by the player C are A [symbol] , 4 [symbol] , J [symbol] , Q [symbol] and K [symbol] , and distributed into the first group 40 of cards (A [symbol] 4 [symbol] ), and the second group 42 of cards (J [symbol] , Q [symbol] , K [symbol] ), so the total score of the player C is equal to five points lower than the total score (ten points) of the banker, and the player C is determined as the loser in the first round comparing step. Referring to FIG. 10, the five-card type of the first group 40 and the second group 42 of the player C is the Club [symbol] flush, and obviously satisfies the requirement of the special card type, so the player C can obtain the reward of the special card type.

The poker game of the invention is executed in the computer system, and the computer system may become the banker.

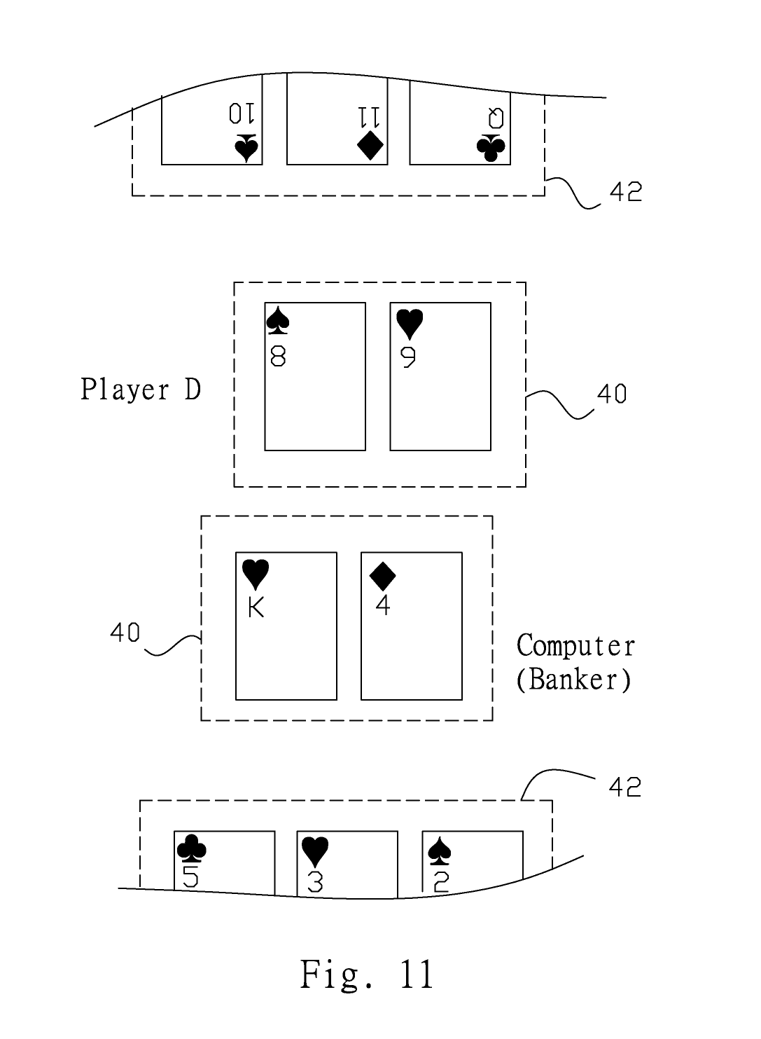

In a fourth example, as shown in FIG. 11, the terminal device of the player D may firstly display two sets of cards, the total scores of which are unknown. Each set of cards may have five cards. The player D may optionally select one of the sets. For example, as shown in the drawing, the five cards selected by the player D are 8 [symbol] , 9♡, 10 [symbol] , J♦ and Q [symbol] ; and the five cards of the computer system are 2 [symbol] , 3♡, 4♦, 5 [symbol] and K♡. Furthermore, the player D has the first group 40 of cards (8 [symbol] , 9♡), and the second group 42 of cards (10 [symbol] , J♦, Q [symbol] ), so the first group of the player D has the total score of 7 (=8+9−10); and the computer system (banker) has the first group 40 of cards (4♦, K♡), and the second group 42 of cards (2 [symbol] , 3♡, 5 [symbol] ), so the first group 40 of the computer system has the total score of 4 (=4+0). It is worth noting that in the first round comparing step, the total score of the player D is higher than that of the computer system.

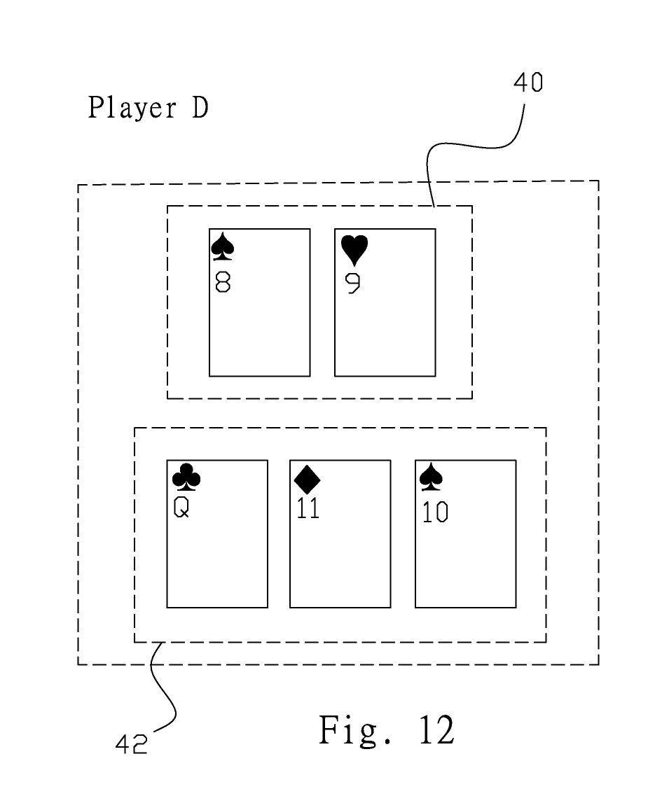

Referring to FIG. 12, according to the requirement of the second round comparing step, the first group 40 and the second group 42 of cards of the player D are combined into a straight satisfying the special card type required in the second round comparing step. Thus, the player D only can obtain the reward of the special card type.

In the invention, a deck of physical poker cards can be utilized to execute the game, a deck of physical poker cards can be utilized in conjunction with the robot for dealing the cards, or an electronic/computer apparatus and a game program can be utilized to execute the game, so the effect of enforceability of the game can be enhanced. Next, the game of the invention can have two rounds of comparing steps, and the comparing contents in the two rounds are different from each other (one of the contents is the total score, and the other of the contents is the special card type). So, the invention can enhance the interest and diversification of the game.

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

What is claimed is:

1. A poker game, comprising:
a computer system;
a plurality of terminal devices connected to the computer system via a network, wherein each of the terminal devices corresponds to a player; and
a game program installed in the computer system and executing:
a dealing step, in which each of the players obtains five cards without knowing contents of the cards obtained by other players when each of the cards is being obtained;
a distributing step, in which each of the players distributes the obtained five cards into a first group and a second group, wherein the first group is composed of two cards, and the second group is composed of three cards;
a first round comparing step, in which each player passing over the distributing step opens the first group of cards, and obtains a score of the first group of cards by way of addition, and the scores of players are compared with each other or one another; and
a second round comparing step, in which the players finishing the first round comparing step re-combine the first group and the second group of cards, and check whether the re-combined cards satisfy a requirement of a special card type, wherein once the five cards of the player satisfy the requirement of the special card type, the player only can obtain a reward of the special card type regardless of a result of the player in the first round comparing step.

2. The poker game according to claim 1, wherein a total score of the second group in the distributing step is requested to be ten points or a multiple of ten points, wherein if the total score of the second group cannot satisfy the requirement, then the player is determined as a loser.
